(19) United States
(12) Patent Application Publication
(10) Pub. No.: US 2009/0278346 A1
(43) Pub. Date: Nov. 12, 2009

(54) CONNECTOR

(76) Inventor: Kevin O'Brien, Boca Raton, FL (US)

Correspondence Address: SHELDON MAK ROSE & ANDERSON PC, 100 Corson Street, Third Floor, PASADENA, CA, 91103-3842, US

(21) Appl. No.: 12/116,473

(22) Filed: May 7, 2008

(51) Int. Cl. F16L 55/00

(52) U.S. Cl. 285/23

(57) ABSTRACT

A connector comprises a body having a passage therethrough for fluid flow and a female portion for receiving by a slip fit a tubular member. Gripping means are placed in the passage in the female portion for gripping the tubular member and is configured for preventing the tubular member from rotating. A retainer retains the gripping means in place and a seal prevents leakage.

### BACKGROUND

Connectors are used in such applications as irrigation sprinkler systems and fire sprinkler systems for connecting tubular members together. The connectors can provide male/male, female/male, and female/female connections. The connectors can be threaded, have a barbed interference fit, or provide a slip fit.

Barbs on the exterior surface of the male end of a connector are often used to create an interference fit when the tubular member is made of a flexible material that can be forced over the barbs to create a seal for liquid that passes through both the connector and the tubular member. This is particularly common in below ground sprinkler systems using inexpensive plastic connectors. In cases such as this the force required to force the tubular member over the exterior barbs of the male end of a connector is great and causes a significant and repeated stress to the hands of the person doing the installation.

For a slip fit female connection, frequently the tubular member is held in the female portion of the connector with an adhesive. This is particularly common in below ground sprinkler systems using plastic connectors. A problem with use of adhesive is the process of applying adhesive is time consuming, and leakage can occur if the adhesive is improperly applied. An attempt to use a gripping mechanism rather than an adhesive resulted in rotation of the tubular member in use.

Accordingly, there is a need for a better system for making connections.

### SUMMARY

The present invention is directed to a connector, also referred to as a fitting, that satisfies this need. The connector has a body with a passage therethrough for fluid flow. It has first and second portions, both portions having an opening therein into the passage. The first portion, also referred to as a female portion, receives by a slip fit a tubular member into the passage. There are gripping means placed in the passage in the female portion for gripping the tubular connector for preventing removal of the tubular connector from the body. The gripping means can be, for example, a ring with teeth projecting inwardly and axially away from the opening of the first portion. The gripping means has an external projection that projects into a detent in the body for preventing rotation of the gripping means, and in doing so preventing the tubular member from rotating.

There can be a retainer in the passage of the first portion for retaining the gripping means in the body. The retainer preferably has an outer wall with a projection thereon that is received by a detent in the body. Similarly, the insert that holds the gripping means in place can have a projection received by the detent. This allows the gripping means and the retainer and the body of the connector to be assembled in alignment with each other and without the need for a secondary manufacturing process such as sonic welding or the application of an adhesive.

Thus, a tubular member can be held securely in the connector, where the connection can be quickly made by a simple slip fit, without the use of adhesive, without the need for any significant force, and without concern that the tubular member may rotate relative to the connector in use.

### DRAWINGS

These and other features, aspects, and advantages of the present invention will become better understood with reference to the following description, appended claims and accompanying drawings where:

FIG. 1 schematically shows two connectors according to the present invention being used with a sprinker system;

FIG. 2 is an exploded perspective view of the connectors of FIG. 1;

FIG. 3 is a perspective view of the assembled connector of FIG. 2; and

FIG. 4 is a sectional view of the connector of FIG. 3.

### DESCRIPTION

A connector 10 according to the present invention, also referred to as a fitting, comprises a body 12, a seal 14, gripping means 16, also referred to as a gripper or lock, and a retainer 18. The body has a passage 20 for fluid flow, a first portion 22 that is capable of providing a female slip fit, and a second portion 24 with external threads 26 for providing a male to female connection. The first portion 20 has an opening 24. The body 12 has an inner wall 30 and a central longitudinal axis 32. A longitudinal slot, also referred to as a detent 34, is in the inner wall 12. The inner wall also has therethrough a plurality of spaced apart circumferential slots 36.

Although the second portion 24 as shown is providing a male threaded fit, the second portion can provide a slip fit and/or a female connection.

As shown in the figures, the first 22 and second 24 portions are transverse to each other, at about a 90° angle. However, the current invention is useful where the first and second portions are aligned or are transverse to each other at an angle other than 90°. In addition, although the body portion 12 is adapted for connecting two tubular members together, the invention is useful for connectors that connect more than two members together, such as a T connector.

The seal 14 can be an annular ring and preferably is made of a flexible material such as a rubber. Exemplary rubbers that can be used are thermoplastic rubbers. A preferred rubber is nitrile rubber.

The preferred gripping means is an annular ring 38 with inwardly projecting teeth 40. The teeth project radially inwardly and axially away from the opening 38. The ring has an external projection 42 fitting on the detent 34.

The retainer 18 likewise is annular in shape and, has a projection 44 fitting into the detent 34 and protuberances 46 sized and shape to snap into the slots 36 of the body 12.

To assemble the connector 10, the seal 14 is placed into the passage 20 against an internal shoulder 48, followed by the gripping means 16, which is seated against the seal 14 with the projection 42 extending into the detent 34. Next, the retainer 18 is placed into the passage 20 to hold the gripping means 16 in place, with the projection 44 in the detent 34 and the protuberances 46 snapped into place into the slots 36, thereby holding the retainer 18 in place without the need for any secondary manufacturing process such as sonic welding or use of adhesive.

Due to the projections 42 and 44 seated in the detent 34, the gripping means 16 and the retainer 18 cannot rotate. Thus, a tubular member held in the passage 20 by the gripping means 16 cannot rotate.

Preferably the body 12 has a finger protector 48 which can comprise a projection extending axially in the passage 20 towards the opening 28. It projects about to the ring 38. A top 50 of the finger protector 48, i.e., the portion closest to the opening 28, is proximate to the teeth 40 and positioned so that a user placing a finger into the passage 20 does not hurt having the finger on the teeth 40.

The body 12 and retainer 18 can be made of any material conventionally used for making connectors, such as a metal or plastics. Exemplary plastics are polyacetals such as polyoxymethyelene, polyvinyl chloride, and polypropylene. Preferably the gripping means 16 is made of metal, such as stainless steel or an engineering plastic.

The connector 10 can be the same size as conventionally used for conventional connectors. For example, it can be used to accommodate ½ inch, ¾ inch, 1 inch and larger tubular members. The first portion 22 and second portion 24 need not be of the same nominal size. For example, the first portion can be adapted for a ¾ inch connection and the second portion 24 adapted for a 1 inch connection.

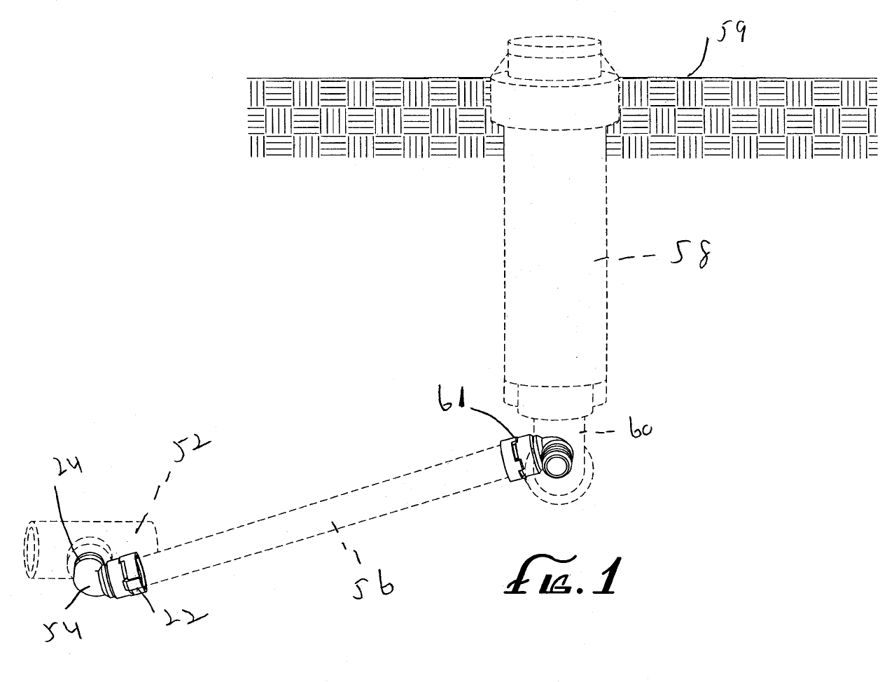

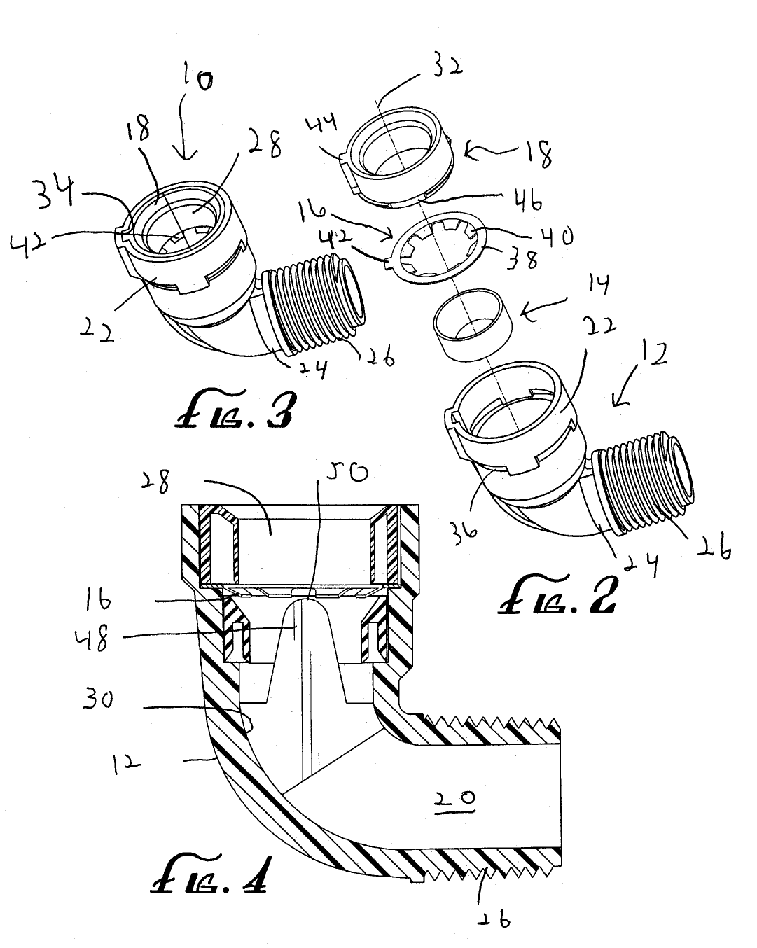

FIG. 1 shows a typical application using a connector 10 according to the present invention, the application being for a lawn sprinkler system. An underground feed line 52 is connected by a first connector 54 according to the present invention to a transverse line 56, which is a tubular member. The second portion 24 of the connector 54, which is a male threaded portion, is threaded into the feed line 52 and the transverse line 52 is slip fitted into the female portion 22. A popup sprinkler head 58 is slightly above ground level 59 and connected to a second more conventional male/female threaded connector 60. The male end of a third connector 61 is threaded into the female end of the male/female threaded connector 60. The other end of the transverse line 56 is then slip fitted into the third connector 61.

The seal 14 is activated by the pressure of the fluid inside the tubular member and the connector to prevent leakage.

Because of the anti-rotation feature of the present invention, the pop-up sprinkler 58 does not rotate freely once installed. This is important both during the installation of a sprinkler system and after it has been completed. During the installation the anti-rotation feature holds the assembly in place until the removed soil has been replaced, a process known as the backfill. After the backfill has been completed, and during regular use, the anti-rotation feature holds that sprinkler in a vertical position that allows for a full 360° degrees of water distribution.

The threaded connection to the feed line 52 preferably is slightly loose. Thus inadvertent pressure on the sprinkler head does not break the sprinkler head or any connections, but rather results in rotation of the first 54 and second 61 connectors.

Although the present invention has been described in considerable detail with reference to certain preferred version thereof, other versions are possible. For example, although the detent is shown as an axially extending slot, it can be of any shape. Also, separate detents can be provided, one for the gripper and one for the retainer.

Also, the retainer need not be included. Instead an internal circumferential groove, which can be continuous or discontinuous, can be provided in the body and the circumferential edge of the gripper can be placed into the groove. Therefore, the spirit and scope of the appended claims should not necessarily be limited to the description of the preferred versions contained herein.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means step” clause as specified in 35 U.S.C. §112.

What is claimed is:

1. An anti-rotation connector comprising:
a) a body having a passage therethrough for fluid flow, a first portion and a second portion, the first portion having an opening for receiving into the passage by a slip fit a tubular member, the first portion having an inner wall with a detent therein, the second portion having an opening therein into the passage; and
b) gripping means placed in the passage in the female portion for gripping the tubular connector for preventing removal of the tubular connector from the body, wherein the gripping means has a projection thereon received by the detent, thereby preventing rotation of the gripping means.

2. The connector of claim 1 also comprising a retainer in the passage of the first portion for retainer the gripping means in place, the retainer having an outer wall with a projection thereon received by the detent.

3. The connector of claim 1 wherein the gripping means has teeth projecting inwardly and axially away from the opening of the first portion.

4. The connector of claim 1 wherein the gripping means comprises a ring with teeth projecting inwardly and axially away from the opening of the first portion.

5. The connector of claim 1 wherein the second portion is adapted for being a male portion of a male—female connection.

6. The connector of claim 1 wherein the first and second portions are transverse to each other.

7. The connector of claim 1 comprising a seal in the passage in the first portion.

8. An anti-rotation connector comprising:
a) a body having a passage therethrough for fluid flow and also having a female portion and a second portion, the female portion having an opening for receiving by a slip fit a tubular member into the passage, the female portion having an inner wall with a detent therein, the female portion having an opening therein into the passage;
b) a lock within the female portion of the passage and comprising a ring with teeth projecting away from the opening of the first portion for locking the tubular member in the female portion;
c) a retainer in the passage in the female portion for retaining the lock in place, the insert having an outer wall with a projection thereon received by a front detent to prevent the tubular member locked in the female portion from rotating; and
d) a flexible seal in the passage in the first portion;
wherein the lock has a projection thereon received by a second detent, thereby preventing rotation of the lock.

9. The connector of claim 8 wherein a slot serves as the first detent and the second detent.
